(19) United States
(12) Patent Application Publication
(10) Pub. No.: US 2012/0088421 A1
(43) Pub. Date: Apr. 12, 2012

(54) METHOD FOR PRODUCING A TEXTILE SEMI-FINISHED GOOD HAVING IMPROVED TOUGHNESS, AND A TEXTILE SEMI-FINISHED GOOD

(75) Inventors: Lars Ischtschuk, Hasbergen (DE); Andreas Palinsky, Moers (DE)

(73) Assignee: SAERTEX GMBH & CO. KG, SAERBECK (DE)

(21) Appl. No.: 13/378,686

(22) PCT Filed: Jun. 15, 2010
(86) PCT No.: PCT/EP10/58420

§ 371 Date: Dec. 16, 2011

(30) Foreign Application Priority Data
Jun. 16, 2009 (DE) 102009025981.3

(51) Int. Cl. B32B 5/30; B32B 5/28; B32B 5/26; B05D 1/00; B05D 3/00

(52) U.S. Cl. 442/148; 427/180; 428/221

(57) ABSTRACT

The object is to improve the prior-art production method for semi-finished textile products with enhanced toughness. The object is achieved by a method for producing a semi-finished textile product, including a toughness-enhancing material, for the production of a composite fiber component, and including the step of: applying the toughness-enhancing material to the exterior surface of individual layers forming a multi-ply fabric, multi-ply fabrics, woven textiles, knitted fabrics, matted fabrics or braided fabrics, or any combination thereof, wherein the toughness-enhancing material includes particles having a particle size in the range of 0.5 μm to 500 μm.

### FIELD OF THE INVENTION

The present invention relates to a method for producing a semi-finished textile product, including a toughness-enhancing material for producing a composite fiber component, and a semi-finished textile product in the form of individual layers forming a multi-ply fabric, multi-ply fabrics, woven textiles, knitted fabrics, matted fabrics or braided fabrics or any combination thereof, and a composite fiber component of such a semi-finished textile product. The multi-ply fabrics can be, in particular, unidirectional, biaxial or multiaxial.

### BACKGROUND OF THE INVENTION

Due to ever more demanding practical requirements the increasing use of so-called toughness-enhancing materials—also referred to as “tougheners” in the industry—for the matrix system is known for the production of high-grade components of a semi-finished fibrous product preimpregnated with a resin system, so-called “composites”. These toughness-enhancing materials have a dampening effect, i.e. they positively influence the delaminating behavior of the semi-finished composite fiber component when it is subjected, for example, to impact stresses, also referred to as an impact. Any damage to the component is thus to be limited or prevented altogether.

This type of “toughness enhancement” has been known for a long time in the processing of preimpregnated semi-finished fibrous products, so-called prepregs. For this purpose, so-called “soft portions” or “soft particles” are introduced into the resin during the production of the preimpregnated semi-finished fibrous products. Usually they are thermoplastic materials or elastomers. Due to their size, they stay in place, and do not pass into or through the fiber bundles. Since preimpregnated semi-finished fibrous products, so-called prepregs, cannot be used in all applications due to their higher cost and poorer drapability, attempts have also been made to use toughness-enhancing materials with infusion or injection components.

For this purpose, it is known from DE 10 2006 039 572 A1 to apply toughness-enhancing materials of a size smaller than 200 nm in liquid form, in particular dispersed silicon grains of a grain size in the nanometer range, to the exterior surface of unidirectional multi-ply fabrics, of individual layers forming a multidirectional multi-ply fabric, of woven textiles, knitted fabrics, matted fabrics or braided fabrics. This approach is based on the idea that it is necessary to disperse toughness-enhancing materials to achieve improved properties of the semi-finished textile products, or of the composite fiber components made of them, in particular if the toughness-enhancing materials have grain sizes in the nanometer range. The reasoning was that it is necessary to distribute the toughness-enhancing material as homogeneously across the fabric as possible to achieve toughness enhancement, in order to prevent a kind of rinsing away during further processing into composite fiber components due to the low viscosity of the matrix resin in comparison with preimpregnated semi-finished fibrous products.

### SUMMARY OF THE INVENTION

It is therefore the object of the present invention to improve the prior-art production method for semi-finished textile products with enhanced toughness.

According to the present invention, the object is achieved by a method for producing a semi-finished textile product, including a toughness-enhancing material for the production of a composite fiber component, comprising the step of: —applying the toughness-enhancing material to the exterior surface of individual layers forming a multi-ply fabric, multi-ply fabrics, woven textiles, knitted fabrics, matted fabrics or braided fabrics, or any combination thereof, wherein the toughness-enhancing material comprises particles having a particle size in the range of 0.5 μm to 500 μm.

The individual layers forming a multi-ply fabric, multi-ply fabrics, woven textiles, knitted fabrics, matted fabrics or braided fabrics, or combinations thereof, will be generically called a textile in the following. The layers forming a multi-ply fabric are also referred to as a ply and form unidirectional or biaxial or multiaxial multi-ply fabrics, in particular.

In contrast to all previous assumptions it has surprisingly been found that improved toughness of semi-finished textile products and composite fiber components made of them can be achieved even without the dispersion of toughness-enhancing materials. In particular, troublesome provision of the toughness-enhancing material as grains having grain sizes in the nanometer range in dispersed form, can be dispensed with. Rather, the toughness-enhancing material can have particles of a size in the micrometer to submillimeter range, preferably in the range of 0.5 μm to 500 μm, particularly preferably in the range of 1 μm to 350 μm, even more particularly preferably in the range of 5 μm to 200 μm. The particles can be individual grains, but also agglomerates of several grains. By saving time and energy in the processing of the toughness-enhancing materials, or by saving costs in procuring the toughness-enhancing materials, semi-finished textile products with enhanced toughness can now be produced in a simpler and more economical manner.

In particularly preferred embodiments, the toughness-enhancing material is applied as a powder. Application in the form of a powder is a dry method of applying the toughness-enhancing material in contrast to application based on a liquid, such as spraying or dipping. This results in an additional significant economy of cost, time and overhead, for the procurement and processing of toughness-enhancing materials, and for the treatment of the textile by the application of the toughness-enhancing material in the form of a powder, and thus semi-finished textile products with enhanced toughness can be produced in a particularly simple and economical manner.

Preferably, the toughness-enhancing material is mixed with a binder prior to application. Particularly preferably, the toughness-enhancing material in powderous form is mixed with a binder in powderous form prior to application, wherein the powder mixture has a particle size in the range of 0.5 μm to 500 μm, preferably in the range of 1 μm to 350 μm, particularly preferably from 5 μm to 200 μm. Depending on the toughness-enhancing material used, the binder can promote or facilitate thermal fixing of the toughness-enhancing material on the textile. It can also be useful for taking up further functional additives to influence the properties of the semi-finished textile product. The binder itself can also assume additional functions, such as the function of a flame-retardant additive. Mixing the two powders is preferably performed in a mechanical manner, such as by stirring, shaking, dry grinding or the like. Similar to the powder of purely toughness-enhancing material, the particles can be individual grains, but also agglomerates of several grains of a size in the micrometer to submillimeter range.

Advantageously, a thermoplastic binder is used. This has a positive effect on thermal fixing of toughness-enhancing material on the textile.

Advantageously, the binder can be chosen taking into account the matrix resin, which is used for further processing the semi-finished textile product into a composite fiber component. An epoxy resin is often used during further processing. Preferably, an epoxy resin is also used as a binder. In particular, an epoxy resin is used having an epoxide equivalent weight in the range of about 700 g/eq. to about 3000 g/eq., preferably from about 800 g/eq. to about 2000 g/eq.

In particularly preferred embodiments, the toughness-enhancing material and binder are mixed at a mixing ratio in weight percent of the binder to the toughness-enhancing material in the range of 50:50 to 30:70. This serves to achieve sufficient toughness with, at the same time, sufficient binding between the toughness-enhancing material and the textile on the one hand, and on the other hand between the semi-finished textile product and the matrix resin in the composite fiber components made thereof.

The toughness-enhancing material can be the usual toughness-enhancing materials used with preimpregnated semi-finished fibrous products. For example, block polymers, such as poly(styrene-b-butadiene-b-methylmethacrylate) (SBM) or poly(methylmethacrylate-b-butylacrylate-b-methylmethacrylate) (MAM) can be used. As a toughness-enhancing material polyorganosiloxanes or a mixture of polyorganosiloxanes is preferably used. It has been found that polyorganosiloxanes have a particularly good toughness-enhancing effect with composite fiber components produced from the semi-finished textile products described here.

Particularly preferably, a toughness-enhancing material is used including grains with a polyorganosiloxane core surrounded by a shell. Polyorganosiloxanes with such a structure, also referred to as a core-shell structure, are commercially available and have the advantage that they are already a powder having particle sizes in the micrometer to submillimeter range, in particular sizes in the range of 5 μm to 200 μm. The particles can be individual particles or also agglomerates of several grains. Advantageously, grains are used with a shell of polymethylmethacrylate. In particular in combination with a binder on an epoxide basis, they result in excellently processable semi-finished textile products that can be further processed to particularly tough composite fiber components. Grains having a shell, for example, on the basis of another polymer or on the basis of a siloxane, can also be advantageously used.

Preferably, the toughness-enhancing material, or the mixture of toughness-enhancing material and binder, is fixed after application. This prevents dusting-off, in particular after application in powder form.

Fixing of the toughness-enhancing material or the mixture of the toughness-enhancing material and the binder can be in any particular fashion, such as thermally, mechanically, chemically, by means of UV radiation, etc. and combinations thereof. Preferably, thermal, mechanical or thermo-mechanical methods, such as on the basis of heating and/or rolling or comparable processes, are particularly preferred. Particularly preferably, the toughness-enhancing material, or the mixture of the toughness-enhancing material and the binder, is thermally fixed on the textile by infrared radiation. Means for infrared irradiation are usually already present in production plants for the production of semi-finished textile products. By using these means also for thermal fixing, the semi-finished textile product can be manufactured in the minimum number of steps and in a particularly cost-effective manner.

Advantageously, the toughness-enhancing material, or the mixture of the toughness-enhancing material and the binder, is applied in an amount in the range of 5 g/m² to 30 g/m². This allows excellent thermal fixing while keeping heat application reasonably low, or short, and results in excellent toughness enhancement. Preferably, application is carried out at relative speeds between the textile to be equipped and the application unit in the range of about 0.5 m/min to about 10 m/min.

Furthermore, the object is achieved by a semi-finished textile product in the form of individual layers forming a multi-ply fabric, multi-ply fabrics, woven textiles, knitted fabrics, matted fabrics or braided fabrics, or any combination thereof, comprising particles of a toughness-enhancing material in the particle size range of 5 μm to 200 μm.

Furthermore, the object is achieved by a composite fiber component of a semi-finished textile product in the form of individual layers forming a multi-ply fabric, multi-ply fabrics, woven textiles, knitted fabrics, matted fabrics or braided fabrics, or any combination thereof, comprising particles of a toughness-enhancing material having particles in the range of 5 μm to 200 μm.

The composite fiber component is preferably produced of the above mentioned semi-finished textile product by means of the usual methods, such as resin-transfer molding (RTM), resin-infusion molding (RIM) or vacuum-assisted process (VAP).

In particularly preferred embodiments, the semi-finished textile product, or the composite fiber component, comprise, as the toughness-enhancing material, polyorganosiloxane particles of a size in the range of 0.5 μm to 500 μm, preferably in the range of 1 μm to 350 μm, particularly preferably in the range of 5 μm to 200 μm, providing the semi-finished textile product, or the composite fiber component, with particularly good toughness.

Both for the semi-finished textile product and for the composite fiber component, the individual layers forming a multi-ply fabric, multi-ply fabrics, woven textiles, knitted fabrics, matted fabrics or braided fabrics, or combinations thereof, will be generically called a textile. The layers forming a multi-ply fabric will also be referred to as plies, and they form, in particular, unidirectional or biaxial or multiaxial multi-ply fabrics.

### BRIEF DESCRIPTION OF THE DRAWINGS

An exemplary embodiment of the invention will be described in the following with reference to the drawing, wherein:

FIG. 1 shows a woven textile equipped with a toughness-enhancing material;

FIG. 2 is a sectional view of a composite fiber component made of the woven textile shown in FIG. 1;

FIG. 3 shows a multi-ply fabric equipped with the toughness-enhancing material;

FIG. 4 is a block diagram of an embodiment of the production method; and

FIG. 5 shows a graph of the delamination surface as a function of impact energy for conventional composite fiber components and composite fiber components comprising the toughness-enhancing material.

### DETAILED DESCRIPTION OF THE INVENTION

In FIG. 1, 1 is a woven textile, known as such, equipped with a layer 2 of a toughness-enhancing material on its top surface. In the example shown in FIG. 1, the toughness-enhancing material has been applied as a powder and subsequently thermally fixed, wherein the toughness-enhancing material has previously been mixed with a binder also present in powder form. In this powder mixture and on the equipped woven textile 1, the toughness-enhancing material is present in the form of particles having a particles size in the range of 5 μm to 200 μm. The binder in layer 2 contributes to thermal fixing of the toughness-enhancing material on the surface of woven textile 1 and is chosen such that, during further processing of the equipped woven textile 1 to a composite fiber component, it dissolves well in the matrix resin used, in order to allow excellent bonding between the matrix resin and the fibrous textile.

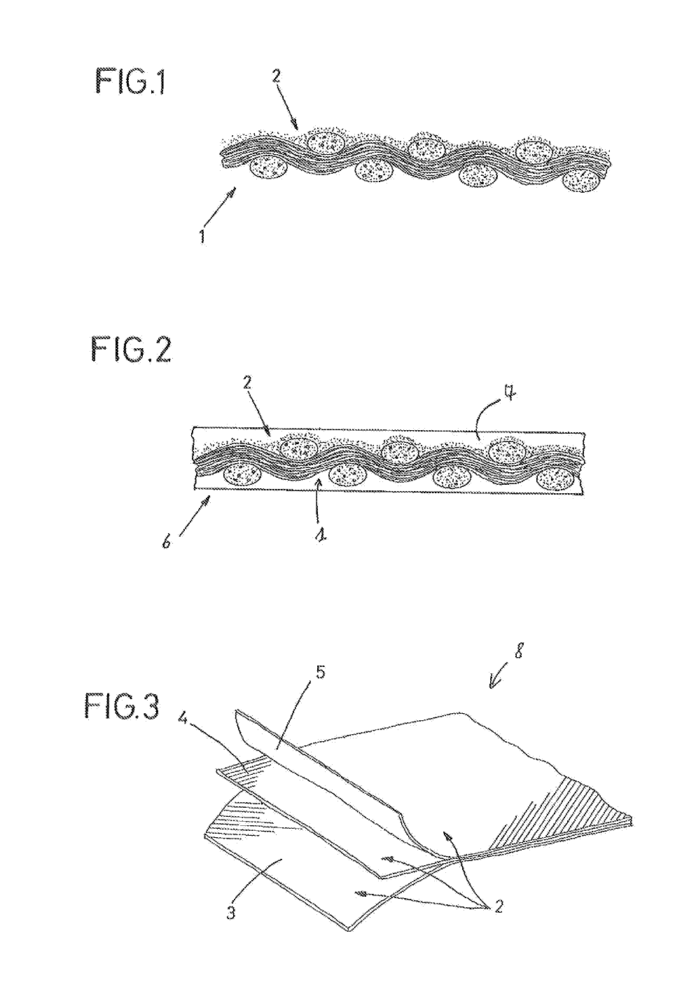

A composite fiber component 6 is shown in FIG. 2, which, in the present example, is produced by means of resin transfer molding, from woven textile 1 discussed with reference to FIG. 1. In the present example, woven textile 1 having layer 2 of the toughness-enhancing material, was placed in a mold, which is then filled with a matrix resin in a resin transfer molding process. The particles of the toughness-enhancing material in layer 2 essentially retain their size during the process.

In the arrangement according to FIG. 3, a multiaxial multi-ply fabric 8 of three structural layers, or plies 3, 4 and 5, is shown, wherein layer 3, for example, is of −45 deg. threads, layer 4 is of 0 deg. threads and layer 5 is of +45 deg. threads. To prevent slippage of layers 3, 4, 5 with respect to each other, they can be sewn together. Toughness-enhancing material 2 in powder form is applied to the top surface of these layers, as shown by arrows, having particles in the particle size range of 40 μm to 200 μm.

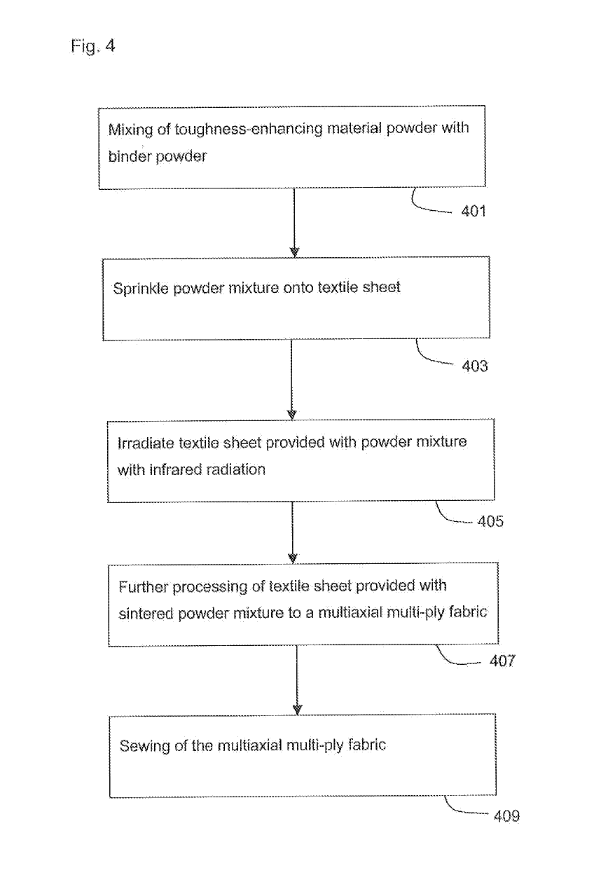

The production of the semi-finished textile product will be explained in more detail in the following with reference to FIG. 4 and a detailed example.

First, the powder to be applied is prepared. This can be done by dry mixing a solid epoxy resin with an epoxide equivalent weight of about 850 g/eq. to about 1000 g/eq., such as Epikote Resin 05311 of Hexion Specialty Chemicals, as a binder with a polyorganosiloxane powder with a core-shell structure, Genioperl P 52 of Wacker Chemie AG, as a toughness-enhancing material (see also step 401 in FIG. 4). The Genioperl P 52 toughness-enhancing material is a powderous polyorganosiloxane having a core-shell structure, wherein the polyorganosiloxanes form the cores of the powder grains, having a shell of polymethylmethacrylate. Most of the grains form agglomerates, having an average size in the range of about 40 μm to about 100 μm.

In a modification of the example shown here, a different suitable binder could also be used. Likewise, a polyorganosiloxane powder with a core-shell structure with a different shell material, e.g. on the basis of silicic acid, or without a core-shell structure, could also be used.

In the present example, the two powders are intensively mixed at a weight ratio of 65 (toughness-enhancing material) to 35 (binder) in a mechanical manner by means of the usual apparatuses, such as ball mills, dry mixers, centrifugal mixers or the like, so that the two materials are as homogeneously mixed as possible. By these means, still existing agglomerates of the toughness-enhancing material, such as P 52, are not necessarily broken up to grain size, and the epoxy resin as a binder also largely keeps the grain size distribution provided by the manufacturer and which is, for example, two-thirds of the grains of Epikote Resin 05311 in a range of about 60 μm to about 150 μm.

The powder mixture can subsequently be applied to the textile by means of standard powder application units (see also step 403). The running speed of the textile was adjusted to about 1 m/min and the application amount was about 15 g/m². Downstream of the application unit, as seen in the running direction of the textile, a standard infrared heating array was arranged, underneath which temperatures in the range of about 120° C. to about 140° C. were reached. The textile had a running speed of about 1 m/min also under the infrared heating array. The heat irradiation (see also step 405) caused sintering of the powder mixture of the toughness-enhancing material and the binder present on the textile in such a manner that agglomerates and grains, as the case may be, of toughness-enhancing material at least partially bond to binder grains and/or agglomerates, and the powder grains or agglomerates at least partially bond with the textile surface.

In the present example, the coated textile consists of coated layers or plies, which are further processed to a multiaxial multi-ply fabric (step 407) and sewn together (step 409) and/or thermally fixed, so that the toughness-enhancing material is present in all intermediate layers and on the surface of the semi-finished textile product. Under impact, this results in particularly efficient protection against delamination of individual layers within the composite fiber component produced with the semi-finished textile product as a reinforcing material by means of the usual methods, such as resin, transfer molding (RTM), resin-infusion molding (RIM) or vacuum-assisted processes (VAP).

Comparable semi-finished textile products and composite fiber components can also be manufactured, for example, on the basis of woven textiles, knitted fabrics, matted fabrics or braided fabrics, or unidirectional, biaxial or multiaxial, or other multi-ply fabrics, or combinations thereof, wherein all or even only individual woven textiles, knitted fabrics, matted fabrics or braided fabrics, multi-ply fabrics or layers can have a toughness-enhancing material with particle sizes in the range of 0.5 μm to 500 μm, preferably in the range of 1 μm to 350 μm, particularly preferably from 5 μm to 200 μm, applied to them.

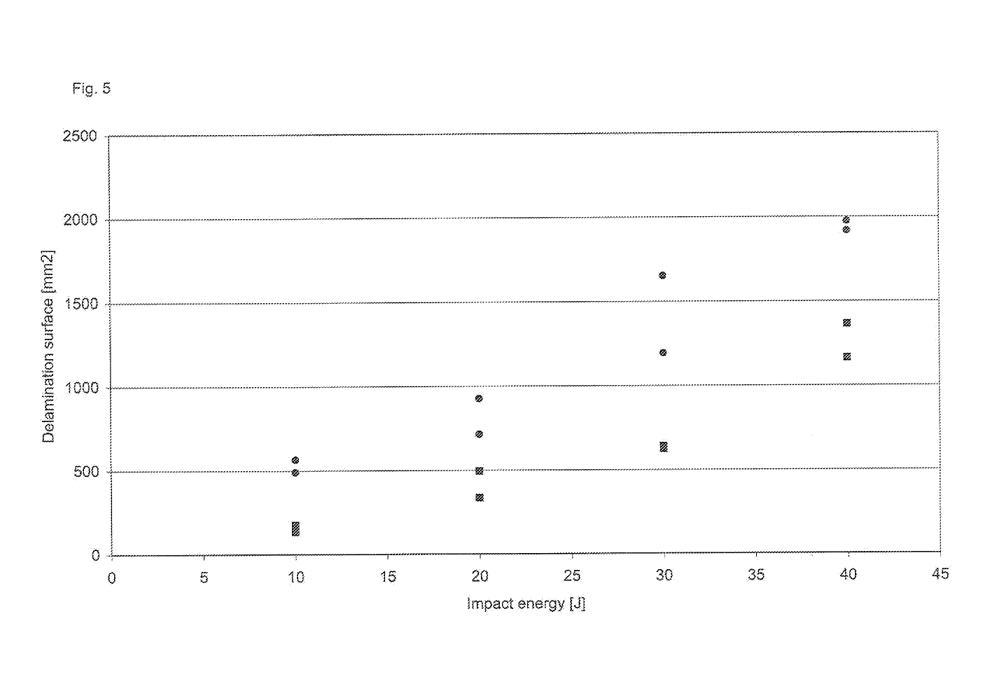

The toughness of composite fiber components made from the above described semi-finished textile products in a resin transfer molding process, with an epoxy resin EPS 600 of Flexion Specialty Chemicals, as a matrix resin, was measured by means of delamination tests. In the test, a ball was dropped from different heights onto the surface of the composite fiber components to achieve different impact energies, and the delamination surface thus produced was measured. The height of the drop of the ball was adjusted such that impact energies of 10 J, 20 J, 30 J and 40 J were achieved on impact on the surface of each composite fiber component. The delamination surface thus produced was plotted as squares in FIG. 5 for the composite fiber components comprising toughness-enhancing material having particle sizes in the micrometer to submillimeter ranges, the delamination surface of reference composite fiber components without toughness-enhancing material was plotted as circles. The measurements have shown with all impact energies that the delamination surfaces on the composite fiber components comprising the toughness-enhancing material having particle sizes in the micrometer to submillimeter ranges were substantially smaller than the delamination surfaces on the reference composite fiber components, in particular, were only half the size, for low impact energies in the range of 10 J to 30 J.

Comparable results were achieved also with composite fiber components manufactured from the above described semi-finished textile products in a resin transfer molding method with the RTM 6 resin system of Hexcel Composites as a matrix resin, which, like the EPS 600 matrix resin, is preferably used for the production of composite fiber components in the aerospace industry.

### LIST OF REFERENCE NUMERALS

1 woven textile
2 layer comprising toughness-enhancing material
3 layer
4 layer
5 layer
6 composite fiber component
7 matrix resin
8 multiaxial multi-ply fabric
401-409 method steps

What is claimed is:

1. A method for producing a semi-finished textile product, comprising a toughness-enhancing material for the manufacture of a composite fiber component, comprising the step of:
applying the toughness-enhancing material on an outer surface of individual layers forming a multi-ply fabric, multi-ply fabrics, woven textiles, knitted fabrics, matted fabrics or braided fabrics, or any combination thereof, wherein the toughness-enhancing material comprises particles having a particle size in the range of 0.5 μm to 500 μm.

2. The method according to claim 1, wherein the toughness-enhancing material is applied as a powder.

3. The method according to claim 1, wherein the toughness-enhancing material is mixed with a binder prior to application.

4. The method according to claim 2, wherein, prior to application, the toughness-enhancing material in powder form is mixed with a binder in powder form, wherein the powder mixture has a particle size in the range of 5 μm to 200 μm.

5. The method according to claim 3, wherein a thermoplastic binder is used.

6. The method according to claim 3, wherein an epoxy resin is used as a binder.

7. The method according to claim 3, wherein the toughness-enhancing material and the binder are mixed at a ratio in weight percent of the binder to the toughness-enhancing material in the range of 50:50 to 30:70.

8. The method according to claim 1, wherein polyorganosiloxanes or a mixture of polyorganosiloxanes is used as the toughness-enhancing material.

9. The method according to claim 1, wherein a toughness-enhancing material is used having grains with a polyorganosiloxane core surrounded by a shell.

10. The method according to claim 1, wherein the toughness-enhancing material, or the mixture of the toughness-enhancing material and the binder, is fixed after application.

11. The method according to claim 10, wherein the toughness-enhancing material, or the mixture of the toughness-enhancing material and the binder, is thermally and/or mechanically fixed.

12. The method according to claim 10, wherein the toughness-enhancing material, or the mixture of the toughness-enhancing material and the binder, is applied using an application amount in the range of 5 g/m² to 30 g/m².

13. A semi-finished textile product in the form of individual layers forming a multi-ply fabric, multi-ply fabrics, woven textiles, knitted fabrics, matted fabrics or braided fabrics, or any combination thereof, that comprises particles of a toughness-enhancing material of a size in the range of 0.5 μm to 500 μm.

14. The semi-finished textile product according to claim 13, wherein polyorganosiloxane particles having a size in the range of 0.5 μm to 500 μm, are used as the toughness-enhancing material.

15. A composite fiber component of a semi-finished textile product in the form of individual layers forming a multi-ply fabric, multi-ply fabrics, woven textiles, knitted fabrics, matted fabrics or braided fabrics, or any combination thereof that comprises particles of a toughness-enhancing material having particle sizes in the range of 0.5 μm to 500 μm.

16. The composite fiber component according to claim 15, that comprises polyorganosiloxane particles of a size in the range of 0.5 μm to 500 μm as the toughness-enhancing material.

17. The method according to claim 2, wherein the toughness-enhancing material is mixed with a binder prior to application.

18. The method according to claim 4, wherein the toughness-enhancing material and the binder are mixed at a ratio in weight percent of the binder to the toughness-enhancing material in the range of 50:50 to 30:70.

19. The method according to claim 7, wherein polyorganosiloxanes or a mixture of polyorganosiloxanes is used as the toughness-enhancing material.

20. The method according to claim 7, wherein a toughness-enhancing material is used having grains with a polyorganosiloxane core surrounded by a shell.
